(19) United States
(12) Patent Application Publication
(10) Pub. No.: US 2024/0053568 A1
(43) Pub. Date: Feb. 15, 2024

(54) DROP WIRE CLAMP AND METHOD OF USE

(71) Applicant: Allied Bolt, Inc, Rye Ridge, NY (US)

(72) Inventors: Glen K. Malin, Rye Brook, NY (US); Jack I. Sachs, Cote Saint Luc (CA)

(73) Assignee: Allied Bolt, Inc., Rye Ridge, NY (US)

(21) Appl. No.: 18/493,900

(22) Filed: Oct. 25, 2023

Related U.S. Application Data
(63) Continuation of application No. 17/117,719, filed on Dec. 10, 2020.
Application No. 17/117,719 is a continuation-in-part of application No. 29/911,389, filed on Sep. 1, 2023.
(60) Provisional application No. 62/953,728, filed on Dec. 26, 2019.

(51) Int. Cl. G02B 6/46; H02G 7/00; H02G 3/32; F16B 7/04; G02B 6/50; G02B 6/48; H02G 1/06

(52) U.S. Cl. CPC G02B 6/475; H02G 7/00; H02G 3/32; F16B 7/0406; G02B 6/50; G02B 6/48; H02G 1/06

(57) ABSTRACT

A drop wire clamp to secure a cable that comprise an outer shell and an inner wedge. The outer shell having a first wall, a second wall, and a shell base to couple the first wall with the second wall. The shell base further defines a shell channel. An inner wedge is receivable in the outer shell and movable between a first position and a second position within the outer shell. The inner wedge has a wedge base defining a wedge channel, wherein the shell channel aligns with the wedge channel in the second position to form a containment structure to house a cable therein. The containment structure includes a length dimension and a width dimension, wherein the length dimension is greater than the width dimension and the length dimension extends in a same direction as the shell base of the outer shell.

### CROSS-REFERENCE TO RELATED APPLICATIONS

This application is a continuation of U.S. patent application Ser. No. 17/117,719, which was filed on Dec. 10, 2020, which claims priority to U.S. Provisional Patent Application No. 62/953,728, which was filed on Dec. 26, 2019, and this application is a continuation-in-part of U.S. Design Pat. application No. 29/911,389, which was filed on Sep. 1, 2023, the entire contents of which are incorporated by reference herein in their entireties.

### FIELD

The disclosed subject matter relates to clamping systems and in particular drop wire clamps. Drop wire clamps are commonly used to secure telephone cables, fiber optic cables, and the like. Such clamps can be used to secure a cable, intermediate at its ends, to a span clamp or house attachment in which a portion of the cable extends beyond the drop wire clamp. These clamps are commonly used to secure a variety of telephone lines or fiber optic cables on the outside of buildings, at a point just short of the position in which these cables enter the building.

Various drop wire clamps have been developed which commonly provide clamping intended to secure a cable. Examples known clamp and other systems are provided in U.S. Pat. Nos. 6,581,251 and 8,517,317, and in U.S. patent application Ser. No. 16/405,584, the disclosure of each of which is herein incorporated by reference in its entirety.

Some known drop wire clamps, however, have deficiencies. For example, many clamps damage the cable itself or the insulation of the structure. Larger clamps are often used to accommodate smaller cables, such as fiber optic cables, and are difficult to secure the smaller cables within the clamp. Often times the small cables move laterally in the clamp and pull through the clamp with little force as known clamps typically secure the wire from only a top and bottom side. Due to the shifting of the cable in the clamp, the cable is often easily cut by the housing of the clamp. Additionally, many clamping systems loosen over a time period. Furthermore, prior art designs apply direct compressive forces on both flat sides of a fiber optic cable and damage the cables therein. Also, some clamps have several parts that can be separated from the clamp and be confusing to assemble. There exists a need for an improved clamp that overcomes at least the above-identified issues.

### SUMMARY

The disclosed subject matter herein provides a drop wire clamp to secure a cable, comprising, amongst other things, an outer shell having a first wall, a second wall, and a shell base to couple the first wall with the second wall, wherein the shell base defines a shell channel; and an inner wedge receivable in the outer shell and movable between a first position and a second position within the outer shell, the inner wedge having a wedge base defining a wedge channel, wherein the shell channel aligns with the wedge channel in the second position to form a containment structure to house a cable therein, wherein the containment structure includes a length dimension and a width dimension, wherein the length dimension is greater than the width dimension and the length dimension extends in a same direction as the first wall and second wall of the outer shell.

According to a further aspect of the invention, there is provided a method of securing a cable in a drop wire clamp comprising, amongst other things, providing a drop wire clamp; inserting a cable within either the shell channel or the wedge channel of the drop wire clamp when the inner wedge is in the first position; and moving the inner wedge between the first position to the second position to secure the cable within the containment structure such that a longitudinal dimension of the cable extends in the direction of the first wall and second wall.

### BRIEF DESCRIPTION OF THE DRAWINGS

The subject matter of the application will be more readily understood from the following detailed description when read in conjunction with the accompanying drawings, in which:

FIG. 1 is an overall front perspective view of the drop wire clamp in a first position according to the disclosed subject matter;

FIG. 2 is an overall back perspective view of the drop wire clamp of FIG. 1 according to the disclosed subject matter;

FIG. 3 is an overall front perspective view of the drop wire clamp with a cable disposed therein in the second position according to the disclosed subject matter;

FIG. 4 is an overall back perspective view of the drop wire clamp of FIG. 3 according to the disclosed subject matter;

FIGS. 5-7 depict top, side, and bottom views of the drop wire clamp with a cable disposed therein in the second position according to the disclosed subject matter;

FIG. 8 is a back view of the drop wire clamp with a cable disposed therein according to the disclosed subject matter;

FIG. 9 is a front view of the drop wire clamp with a cable disposed therein according to the disclosed subject matter;

FIG. 10A is a sectional view of the drop wire clamp of FIG. 6 along lines A— A according to the disclosed subject matter; FIG. 10B is an enlarged view of the containment structure of FIG. 10A; FIG. 10C is an alternative embodiment of FIG. 10B;

FIG. 11 is a perspective view of the outer shell according to the disclosed subject matter;

FIG. 12 is a side view of the outer shell according to the disclosed subject matter;

FIG. 13 is a back view of the outer shell according to the disclosed subject matter;

FIG. 14 is a front view of the outer shell according to the disclosed subject matter;

FIG. 15 is a sectional view of the outer shell of FIG. 14 along lines B—B according to the disclosed subject matter;

FIG. 16 is a detailed view of the raised edges of the friction engaging surface of FIG. 13 according to the disclosed subject matter;

FIG. 17 is a top view of the shell base according to the disclosed subject matter;

FIG. 18 is a perspective view of the inner wedge shell according to the disclosed subject matter;

FIG. 19 is a top view of the wedge base according to the disclosed subject matter;

FIG. 20 is a side view of the inner wedge according to the disclosed subject matter;

FIG. 21 is a detailed view of the bail wire attachment flange of FIG. 20 according to the disclosed subject matter;

FIG. 22 is a front view of the inner wedge according to the disclosed subject matter;

FIG. 23 is a detailed view of the raised edges of the friction engaging surface of FIG. 22 according to the disclosed subject matter;

FIG. 24 is a bail wire of the clamp prior to attachment according to the disclosed subject matter.

FIG. 25 is a cross sectional view of an exemplary fiber optic mini cable that is secured by the drop wire clamp according to the disclosed subject matter.

FIG. 26 is a cross sectional view of a drop wire clamp according to an alternative embodiment of the disclosed subject matter.

### DETAILED DESCRIPTION

The disclosed subject matter herein provides a drop wire clamp to secure a cable, comprising, amongst other things, an outer shell having a first wall, a second wall, and a shell base to couple the first wall with the second wall, wherein the shell base defines a shell channel; and an inner wedge receivable in the outer shell and movable between a first position and a second position within the outer shell, the inner wedge having a wedge base defining a wedge channel, wherein the shell channel aligns with the wedge channel in the second position to form a containment structure to house a cable therein, wherein the containment structure includes a length dimension and a width dimension, wherein the length dimension is greater than the width dimension and the length dimension extends in a same direction as the first wall and second wall of the outer shell.

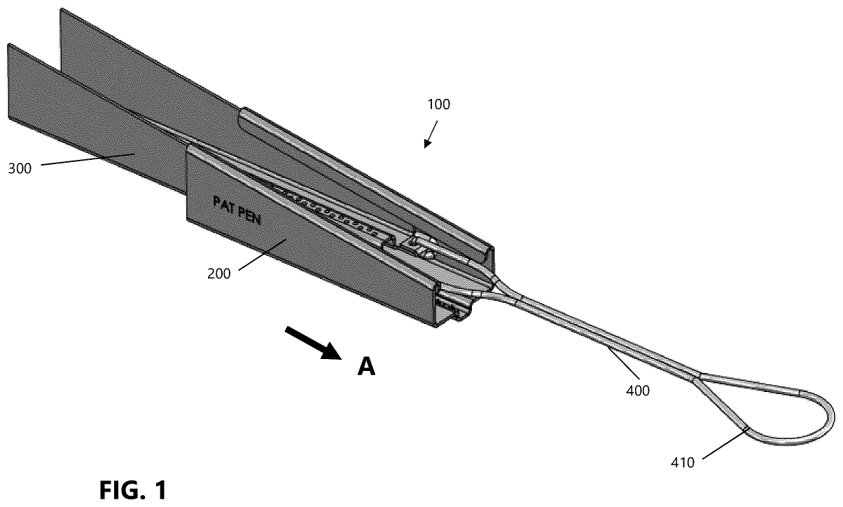

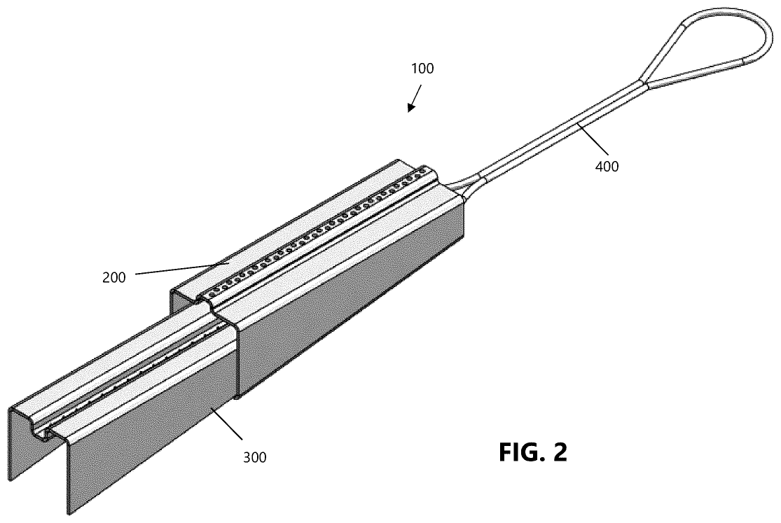

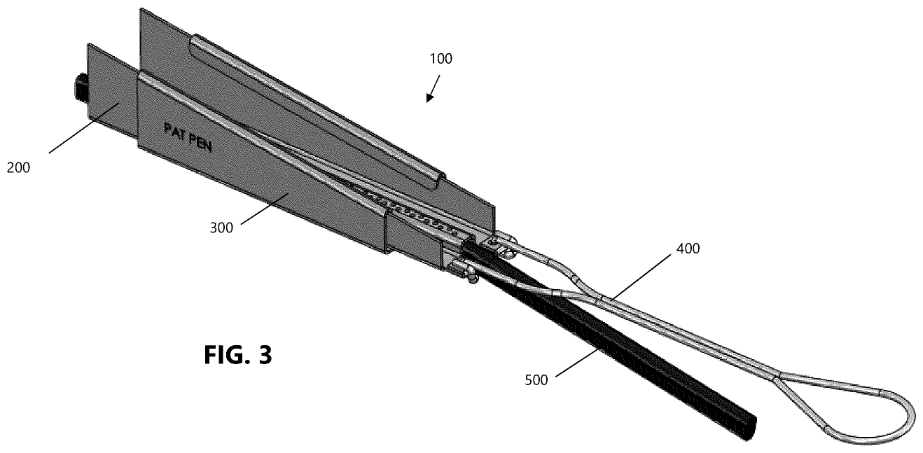

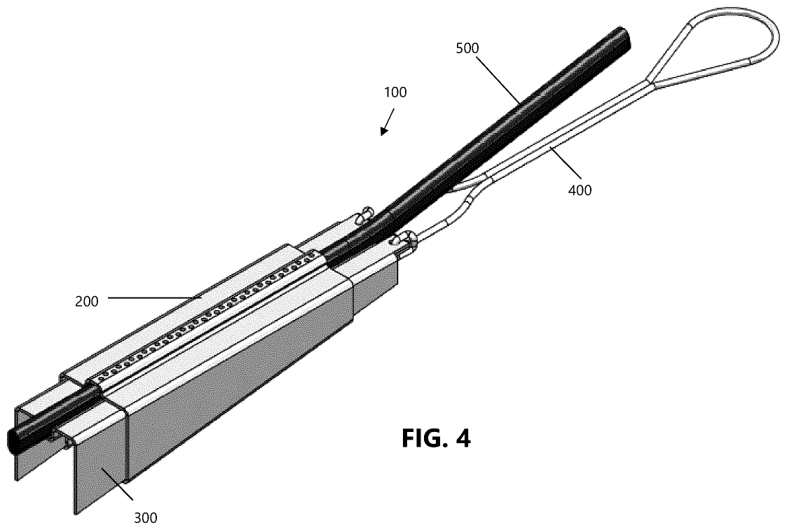

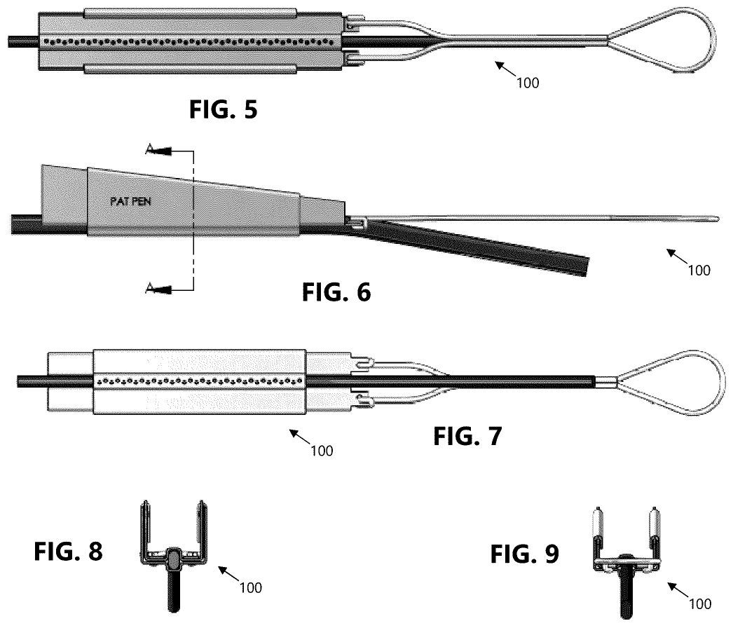

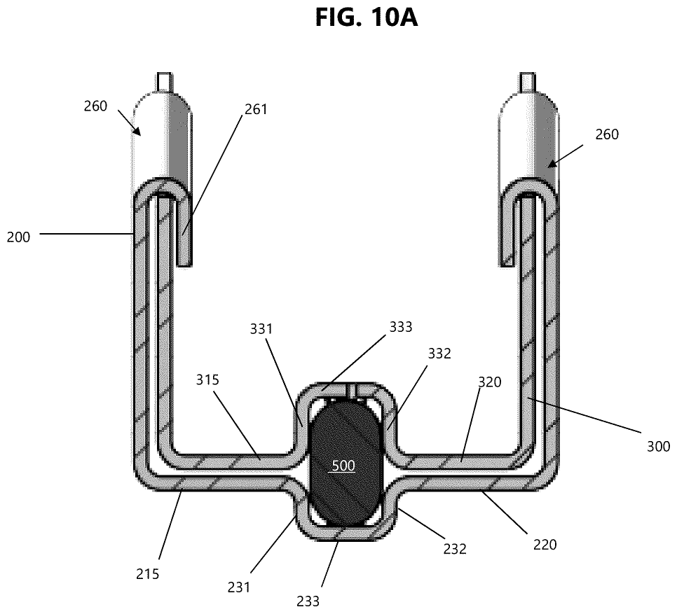

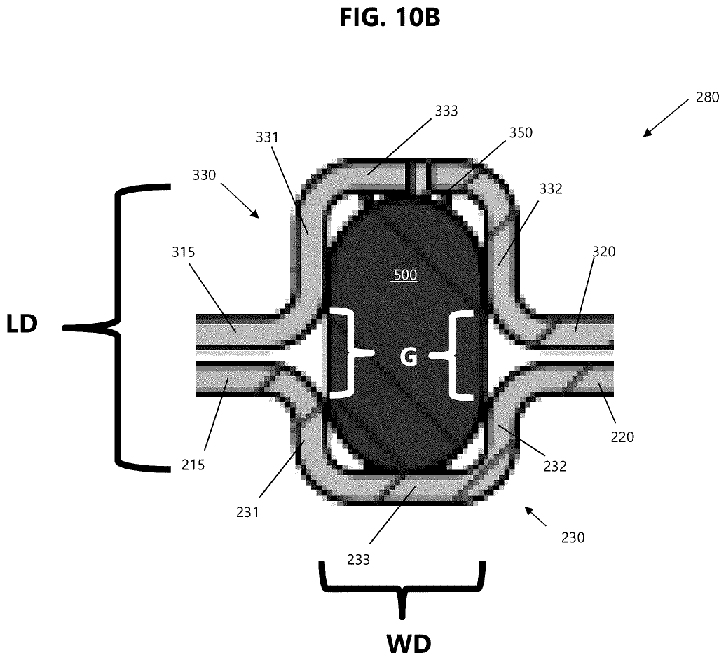

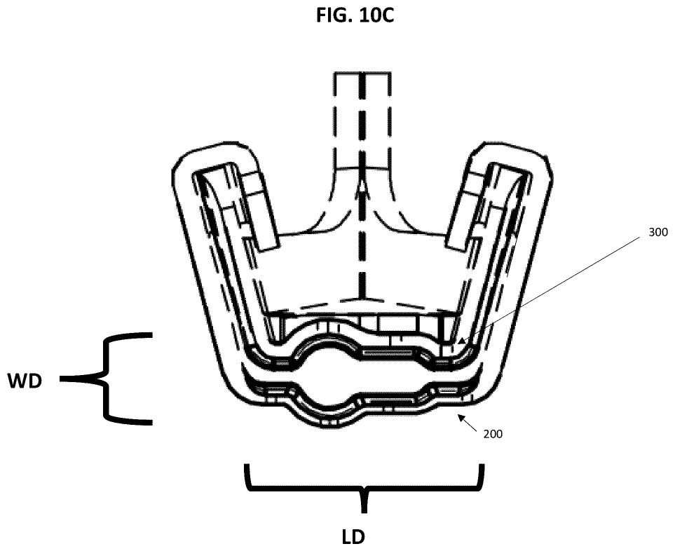

FIGS. 1 and 2 provide an overall perspective view of an embodiment of the subject matter. A drop wire clamp 100 is provided having a two-piece construction. As shown, the clamp 100 has an outer shell 200 and an inner wedge 300 with a bail wire 400. The outer shell 200 and inner wedge 300 cooperate together to secure a cable between the outer shell 200 and inner wedge 300, as described with respect to FIGS. 3-10. FIGS. 1 and 2 depict the drop wire clamp 100 in a first, unlocked position. Between the first, unlocked position and a second locked position, the inner wedge 300 is longitudinally insertable into the outer shell 200, as further discussed herein. FIG. 3 depicts a front perspective view of the drop wire claim of FIG. 1 in the second position, with a cable 500 disposed therein, and FIG. 4 depicts a back perspective view thereof. FIGS. 5-7 depict top, side, and bottom views of the drop wire clamp 100 of FIG. 3 with cable 500 disposed therein. FIGS. 8 and 9 depict back and front views of the drop wire clamp with a cable disposed therein, respectively. FIG. 10A is a sectional view of the drop wire clamp of FIG. 6 along lines A—A according to the disclosed subject matter, and further discussed herein. FIG. 10B is an enlarged view of a portion of FIG. 10A.

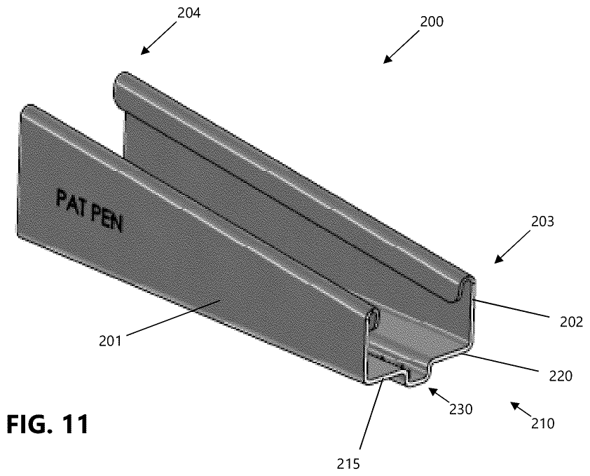

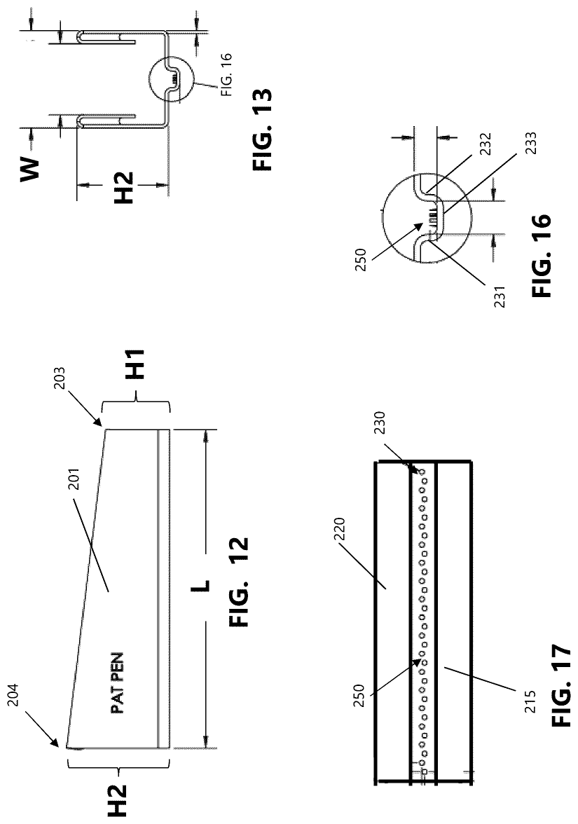

FIG. 11 is a perspective view of the outer shell 200 according to the disclosed subject matter. The outer shell 200 includes a first shell wall 201, a second shell wall 202, a first end 203, and a second end 204, as provided in FIG. 11. As best shown in the side view of FIG. 12, the walls 201, 202 increase in height along the longitudinal length L of the shell from the first end 203 to the second end 204. As such, a height dimension of the first end of the outer shell 200 is smaller than a height dimension of the second end of the outer shell 200. The first shell wall 201 and the second shell wall 202 are substantially the same and mirror images of each other. Thus, at the first end 203, the first shell wall 201 and the second shell wall 202 have the same height H1, as provided in FIG. 12. At the second end 204, the sidewalls 201, 202 have the same height H2, as provided in FIGS. 12 and 13. In one embodiment, H1 is approximately 0.5 inches and H2 is approximately 1 inch. Other heights are contemplated herein and the preceding dimensions are provided merely as an example.

As depicted in FIG. 11, the outer shell 200 further includes a shell base 210 to couple the first wall 201 with the second wall 202. As such, the first wall 201 and second wall 202 extend upward from the shell base 210. The shell base 210 and the shell walls 201, 202 make an approximate U-shaped configuration, as provided in the figures.

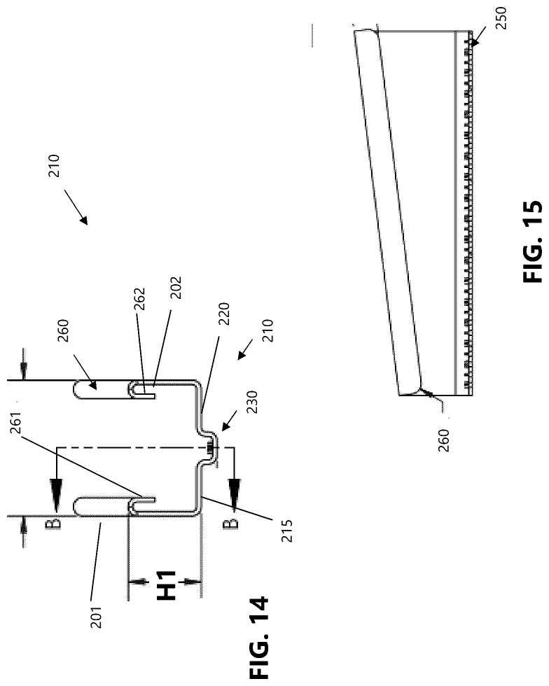

FIG. 14 is a front view of the outer shell and FIG. 15 is a sectional view of the outer shell of FIG. 14 along lines B—B. As depicted in FIG. 14, the shell base 210 defines a first planar member 215, a second planar member 220, and a recessed shell channel 230 that couples the first planar member with the second planar member. The shell base 210 includes an inside surface and an outside surface. The inside surface can include an inner friction engaging surface 250 along the shell channel 230 to engage the cable 500 with outer shell 200, as provided in the figures. In one embodiment, the friction engaging surface includes a plurality of holes with raised edges surrounding the holes, as shown in FIGS. 14-16. In one embodiment, the raised edges can be approximately 0.04 inches in height. In another embodiment, the inner friction engaging surface 250 includes flat ridges or teeth. The ridges can be affixed to the shell subsequent to the formation of the outer shell 200. Alternatively, the outer shell with the ridges can be a monolithic structure. The ridges can be stepwise linear along the inside base. The friction engaging surface 250 of the shell channel 230 can extend a length of the outer shell, as shown in the cross sectional view of FIG. 15 and the top view of FIG. 17. Alternatively, the friction engaging surface can extend along a portion of the length of the outer shell. In alternative embodiments, the inside surface of the shell base 210 can include a smooth surface without any friction engaging members.

The shell channel 230 includes a first sidewall 231, a second sidewall 232, and a bottom wall 233 coupled to the first and second sidewalls 231, 232. The first sidewall, second sidewall, and bottom wall define a portion of the containment structure 280 as further defined herein. In one example, the sidewalls 231, 232 can have a height of approximately 0.13 inches and the bottom wall 233 can have a width of approximately 0.19 inches. FIG. 17 is a top view of the shell base according to the disclosed subject matter. As depicted, the first planar member 215, the second planar member 220, and the shell channel 230 extend a length of the outer shell. The friction engaging surface 250 in this embodiment includes offset holes along the length of the shell.

The dimensions of the outer shell 200 can vary. For example, but not limited to, the length L of the outer shell 200 can be approximately 3.5 inches and the width of the shell W can be approximately 1 inch. The longitudinal dimension of the outer shell 200 is less than the longitudinal dimension of the inner wedge 300, as shown in FIG. 3. The thickness of the outer shell 200 can vary. For example, but not limited to, the outer shell 200 can have a uniform thickness of approximately 0.03 inches.

The first and second shell walls 201, 202 each have a top longitudinal ridge functioning as a guide conduit 260. The guide conduit 260 includes inwardly bent ends of the walls 201, 202 to create walls 261, 262. The bend ends form respective channels between the walls 201, 202 and the walls 261, 262 respectively, as depicted in FIG. 14. The walls 261, 262 can be approximately 0.25 inches in height to safely secure the walls of the inner wedge therein, as further discussed herein. The channels have an approximately U-shaped cross-section.

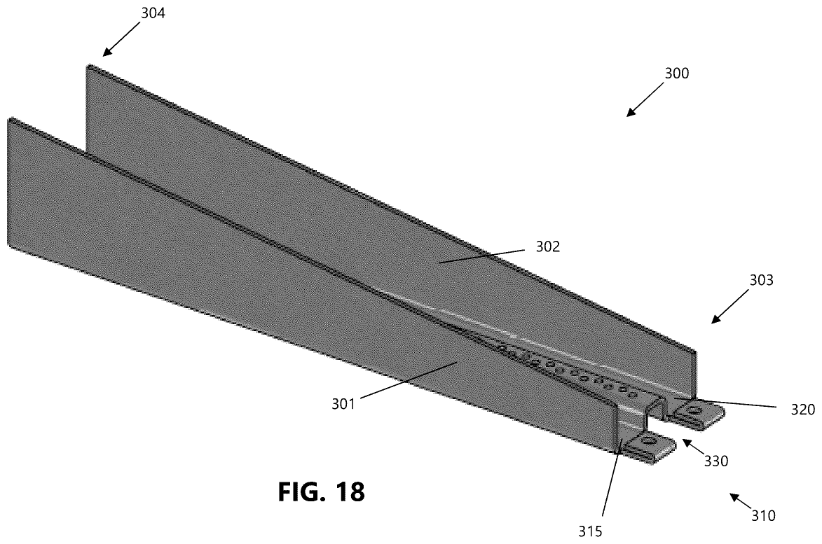

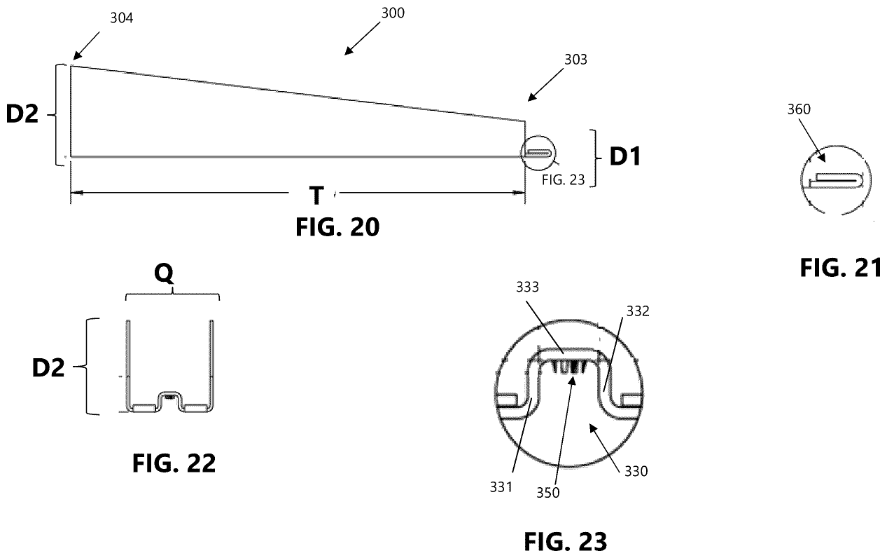

FIGS. 18-24 depict the inner wedge 300 that is coupleable with and receivable in the outer shell 200. The inner wedge 300 is movable between a first position and a second position within the outer shell 200, as further discussed herein. FIG. 18 is a perspective view of the inner wedge 300 according to the disclosed subject matter. The inner wedge 300 includes a first wedge wall 301, a second wedge wall 302, a first end 303, and a second end 304, as provided in FIG. 18. As best shown in the side view of FIG. 20, the walls 301, 302 increase in height along the longitudinal length T of the wedge from the first end 303 to the second end 304. The first wedge wall 301 and the second wedge wall 302 are substantially the same and mirror images of each other. Thus, at the first end 303, the first wedge wall 301 and the second wedge wall 302 have the same height D1, as provided in FIG. 20. At the second end 304, the sidewalls 301, 302 have the same height D2, as provided in FIGS. 20 and 22. In one embodiment, D1 is approximately 0.35 inches and D2 is approximately 1 inch. Other heights are contemplated herein and the preceding dimensions are provided merely as an example.

The respective ends of the first and second wall 301, 302 of the wedge base can slide within respective guide conduits 260 of the outer shell 200, as shown in FIG. 1. The guide conduits provide a further locking feature to secure the inner wedge with the outer shell.

As depicted in FIG. 18, the inner wedge 300 further includes a wedge base 310 to couple the first wall 301 with the second wall 302. As such, the first wall 301 and second wall 302 extend upward from the wedge base 310. The wedge base 310 and the wedge walls 301, 302 make an approximate U-shaped configuration, as provided in the figures.

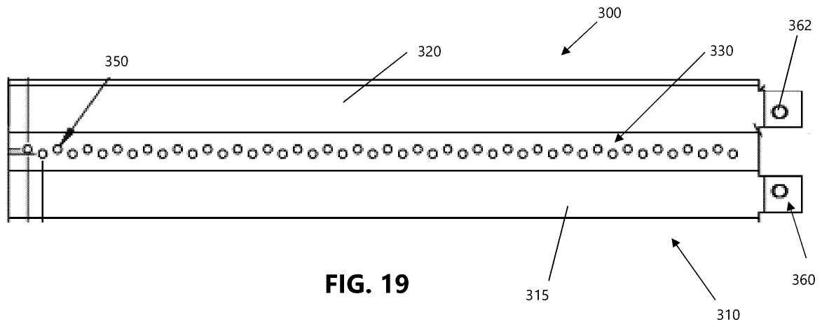

As depicted in FIGS. 18 and 19, the wedge base 310 defines a first planar member 315, a second planar member 330, and a raised wedge channel 330 that couples the first planar member with the second planar member. The wedge base 310 includes an inside surface and an outside surface. The outside surface can include an inner friction engaging surface 350 along the wedge channel 330 to engage the cable 500 with inner wedge 300, as provided in the figures. In one embodiment, the friction engaging surface includes a plurality of holes with raised edges surrounding the holes, as shown in FIGS. 19, 22 and 23. In another embodiment, the inner friction engaging surface 350 includes flat ridges or teeth. The ridges can be affixed to the wedge subsequent to the formation of the inner wedge 300. Alternatively, the inner wedge with the ridges can be a monolithic structure. The ridges can be stepwise linear along the inside base. The friction engaging surface 350 of the shell channel 330 can extend a length of the inner wedge, as shown in the top view of FIG. 19. Alternatively, the friction engaging surface can extend a portion of the length of the inner wedge. The friction engaging surface of the shell channel and the friction engaging surface of the wedge channel can each include the plurality of holes with raised edges surrounding the holes such that the holes of the shell and wedge are offset from each other. In alternative embodiments, the outside surface of the wedge base 310 can include a smooth surface without any friction engaging members. As such, the shell base and the wedge base can each include smooth inside and outside surfaces, respectively in alternative embodiments.

As shown in FIGS. 10A and 23, the raised wedge channel 330 includes a first sidewall 331, a second sidewall 332, and a top wall 333 coupled to the first and second sidewalls 331, 332. The first sidewall, second sidewall, and top wall define a portion of the containment structure 280, as further defined herein. In one example, the sidewalls 331, 332 can have a height of approximately 0.13 inches and the top wall 333 can have a width of approximately 0.19 inches. The top view of FIG. 19 depicts the first planar member 315, the second planar member 330, and the wedge channel 330 extending a length of the inner wedge. The friction engaging surface 350 in this embodiment includes offset holes along the length of the wedge.

The dimensions of the inner wedge 300 can vary. For example, but not limited to, the length T of the inner wedge 300 can be approximately 5 inches and the width of the shell Q can be approximately 0.9 inches. The inner wedge can be longer in dimension that the outer shell, as shown in FIG. 3. The thickness of the inner wedge 300 can vary. For example, but not limited to, the inner wedge 300 can have a uniform thickness of approximately 0.03 inches. However, the dimensions of the inner wedge must complement the dimensions of the outer shell 200 so that the dimensions of the inner wedge 300 is smaller and fits within the shell walls 201, 202. Thus, a height dimension of the first end of the inner wedge 300 is smaller than a height dimension of the second end of the inner wedge 300.

As depicted in FIG. 18, the inner wedge 300 further includes a bail wire attachment zone for attaching a bail wire 400 to the inner wedge 300. For the bail wire attachment zone, the first planar member 315 and the second planer member 320 extend beyond the first end 303 of the walls 301, 302 and bend about themselves to form respective bail wire attachment flanges 360, as shown in FIGS. 18 and 20. FIG. 21 is a detailed side view one of the bail wire attachment flanges 360 of FIG. 20 according to the disclosed subject matter. The flanges 360 can define a recess 362 to receive the ends of the bail wire for further securement.

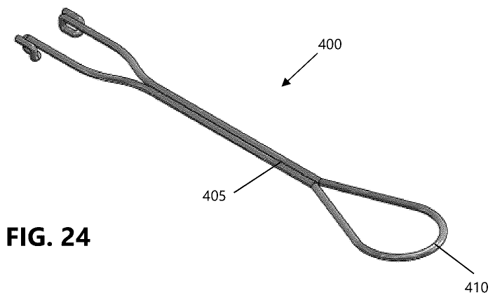

FIG. 24 is the bail wire 400 of the clamp prior to attachment according to the disclosed subject matter. The bail wire 400 can include a tail wire 405 with a loop 410. The tail wire 405 can be secured to the inner wedge, such as at the wedge base 310. The ends of the tail wire can attach to the bail wire attachment flanges 360 as shown in FIG. 1. For example, the ends of the bail wire can be crimped securely to each side of the wedge at the flanges 360. In another embodiment, the bail wire is insertable into a housing on the wedge base and subsequently secured. In another embodiment, the bail wire is monolithic with the inner wedge 300. The length of the bail wire 400 can vary.

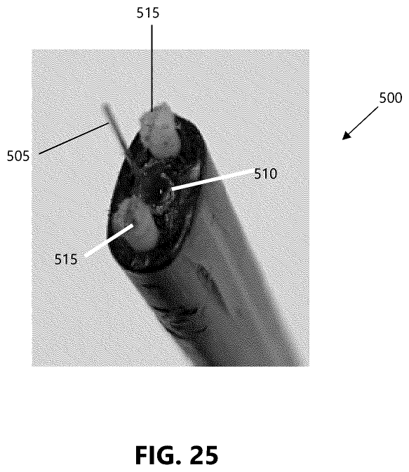

FIG. 25 is a cross sectional view of an exemplary cable 500 that can be secured with the clamp 100, according to the disclosed subject matter. The cable 500 of FIG. 25 is a flat fiber optic mini cable having two flat longitudinal sides. For purposes of example, the cable can be a fiber optic mini cable or bundle 505 that is disposed in a tube 510, such as a protective gel filled tube. The tube 510 is approximately centered in the cable 500, as shown in FIG. 25. The cable can further include two fiberglass rods 515 diametrically opposed to each other on either side the tube 510 to further protect the fiber optic cable 505 and provide strength to the cable 500. The cable 500 can have a variety of cross-sectional shapes such as oblong, round, rectangular, and the like as known in the art. Generally, the cable includes a transverse dimension and a longitudinal dimension, such that the transverse dimension is shorter than the longitudinal dimension. As shown in FIG. 25, the fiberglass rods and the tube 510 are disposed successively along the longitudinal dimension of the cable 500.

As referenced above, the inner wedge 300 is longitudinally insertable in the shell in the direction of A, as shown in FIG. 1. The inner wedge 300 is receivable in the outer shell 200 such that the wedge and shell are movable between a first position and a second position. The inner wedge 300 is positioned above the outer shell 200 to house the cable. The shell channel 230 aligns with the wedge channel 330 in at least the second position to form the containment structure 280 to house a cable therein. The containment structure includes a length dimension LD and a width dimension WD, as shown in the enlarged view of FIG. 10B. The length dimension is greater than the width dimension, as shown. In one example, the length dimension LD is at least approximately 0.32 inches and the width dimension WD is at least approximately 0.18 inches. Although the embodiment of FIG. 10B depicts the length dimension as parallel to the walls of the clamp, alternative embodiments contemplate reversing the position of the length and width dimensions, as shown in FIG. 10C. The dimensions of the containment structure 280 include the maximum allowable volume to receive a cable therein. As such, the length dimension LD is greater than the sum of the length of the first sidewalls 231, 331, as explained herein.

The containment structure 280 includes the housing defined by the top wall 333, the bottom wall 233, the first sidewalls 231, 331 of the shell channel and wedge channel respectively, and the second sidewalls 232, 332 of the shell channel and wedge channel respectively. Accordingly, the containment structure 280 can comprise a rectangular configuration. As shown in FIG. 10B, the first sidewall 231 of the shell channel is distanced from the first sidewall 331 of the wedge channel by a gap dimension G. Likewise, the second sidewall 232 of the shell channel is distanced from the second sidewall 332 of the wedge channel by the gap dimension G. Thus, As such, the length dimension LD is the sum of the length of the first sidewalls 231, 331 plus the gap dimension G, as explained herein. As designed, the containment structure is configured to impart direct compression on the cable 500 within the containment structure discontinuously. Accordingly, the containment structure can impart direct force to the cable 500 except along the gap dimension G, which includes a portion of the cable that does not directly interface with a sidewall 231, 331, 232, 323 when the inner wedge 300 is in the second position. Accordingly, the containment structure does not impart any direct compressive forces to an optical fiber bundle within a cable contained within the containment structure as such bundle is aligned with the gap dimension G. Thus, the first and second sidewalls 231, 331, 232, 323 of the shell channel and the wedge channel are configured to engage with a top portion and bottom portion of the longitudinal sides of the cable within the containment structure 280. Furthermore, within the containment structure 280, the top wall 333 and the bottom wall 233 are configured to engage with a transverse side of the cable within the containment structure 280.

The gap dimension G is at least a diameter dimension of an optical fiber bundle within a cable contained within the containment structure. With respect to the exemplary cable 500 of FIG. 25, the gap dimension G is at least the diameter of the tube 510. In one example, the gap dimension G is at least approximately 0.06 inches.

As depicted in FIGS. 10A and 10B, the top wall 333 has a friction engaging surface 350 that engages the cable at the given cross-section A—A of FIG. 6. In this embodiment, the friction engaging surfaces 250, 250 include an alternating pattern of holes so that the friction engaging surfaces of either the shell or the wedge alternatively grip the cable. As shown, the first and second sidewalls 231, 331, 232, 323 of the shell channel and the wedge channel can include smooth surfaces to distribute the compression force on the cable on an equal distribution. The first and second members of the shell base and wedge base can further include smooth surfaces to facilitate ease of sliding the inner wedge with respect to the outer shell between the first and second positions. The first members of the shell base and wedge base engage each other in the second position and the second members of the shell base and wedge base engage each other in the second position, as shown in FIG. 10A.

The inner wedge 300 can be inserted into the shell by a force exerted upon the second end of the wedge. For example, a hammer can tap the wedge into the outer shell 200 to secure the cable 500 in the clamp 100. Alternatively, the inner wedge 300 can be pulled into the shell with the bail wire 400 to lock the inner wedge 300 with the outer shell 200. The bail wire 400 can also be used to unlock the clamp 100 to allow the cable 500 to be released from the clamp 100. To unlock the clamp 100, the bail wire 400 should be pushed in the direction opposite that of direction A, as provided in FIG. 1. The clamp 100 can further include a drip loop positioned at a second end of the clamp, either at the second end of the outer shell or the second end of the inner wedge. The drip loop is configured to house excess cable for storage. As such, the drip loop can help guide and support the cable while looping in mid-air, at a pole, at mid-span and at the building structure. The drip loop can further assist in stormwater management by providing a path for rain water to roll off the clamp instead of traveling along the cable and into a building structure attached to the cable.

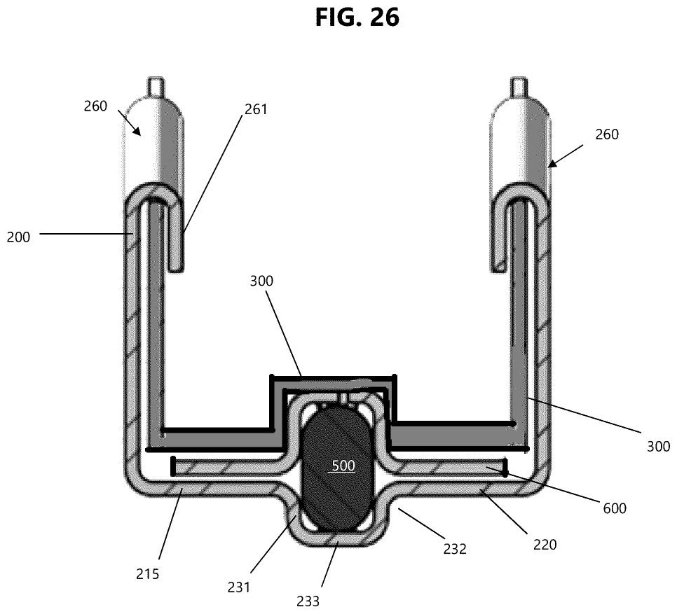

Although the wedge channel is depicted integral with the inner wedge in the above embodiments, it is herewith contemplated that the wedge channel that comprises an upper portion of the containment structure could be located on an intermediary component, such as a shim 600. An example of such alternative embodiment of a drop wire clamp as a three-piece construction is provided in a cross sectional view of FIG. 26. In such embodiment, the shim 600 defines the channel of the upper portion of the containment structure in a similar manner as disclosed above. Separately, a wedge 300 can be provided to cooperate with and complement the shim, as disclosed in U.S. Pat. No. 8,517,317, the contents of which are incorporated herein in its entirety. The shim can provide added stability to the cable within the drop wire clamp.

The drop wire clamp can be manufactured from a plurality of materials. In one embodiment, the clamp is manufactured from a metal, for example, but not limited to stainless steel, aluminum, plastic, or the like. The drop wire clamp according to the disclosed subject matter provides excellent crush resistance and tensile strength for the cable during installation and protects the cable during use and suspension. Furthermore, the two-piece construction is configured for quick assembly and ease of manufacture and use.

According to a further aspect of the disclosed subject matter, there is provided a method of securing a cable in a drop wire clamp comprising, amongst other things, providing a drop wire clamp with any of the features disclosed herein. The method further includes inserting a cable within either the shell channel or the wedge channel of the drop wire clamp when the inner wedge is in the first position; and moving the inner wedge between the first position to the second position to secure the cable within the containment structure such that a longitudinal dimension of the cable extends in the direction of the first wall and second wall. The method further includes pulling the bail wire to move the inner wedge between the first position and the second position. Ultimately, the bail wire with the cable secured therein can be secured to at least one of a pole, house, and building support attachment.

It will be understood that the above description of the present invention is susceptible to various modifications, changes and adaptations, and the same are intended to be comprehended within the meaning and range of equivalents of the appended claims.

What is claimed is:

1. A drop wire clamp to secure a cable, comprising:
an outer shell having a first wall, a second wall, and a shell base to couple the first wall with the second wall, wherein the shell base defines a shell channel; and
a monolithic inner wedge receivable in the outer shell and movable between a first position and a second position within the outer shell, the monolithic inner wedge having a wedge base defining a wedge channel,
wherein the shell channel aligns with the wedge channel in the second position to form a containment structure to house a cable therein, wherein the containment structure includes a length dimension and a width dimension, wherein the length dimension is greater than the width dimension and the length dimension extends in a same direction as the shell base of the outer shell.

2. The drop wire clamp of claim 1, wherein the shell channel includes a first sidewall, a second sidewall, and a bottom wall coupled to the first and second sidewalls;
wherein the wedge channel includes a first sidewall, a second sidewall, and a top wall coupled to the first and second sidewalls of the wedge channel; and
wherein the containment structure includes the top wall, the bottom wall, and the first and second sidewalls of the shell channel and wedge channel respectively, wherein the top wall and the bottom wall are configured to engage with a longitudinal side of a cable within the containment structure.

3. The drop wire clamp of claim 2, wherein the first sidewall of the shell channel is distanced from the first sidewall of the wedge channel by a gap dimension and the second sidewall of the shell channel is distanced from the second sidewall of the wedge channel by the gap dimension such that the containment structure is configured to impart compression on a cable within the containment structure except along the gap dimension when the monolithic inner wedge is in the second position.

4. The drop wire clamp of claim 3, wherein the gap dimension is at least a diameter dimension of an optical fiber bundle within a cable contained within the containment structure.

5. The drop wire clamp of claim 2, wherein the first and second sidewalls of the shell channel and the wedge channel are configured to engage with a top portion and bottom portion of a transverse side of a cable within the containment structure.

6. The drop wire clamp of claim 2, wherein at least one of the top wall and the bottom wall includes a friction engaging surface configured to engage a cable within the containment structure.

7. The drop wire clamp of claim 6, wherein the friction engaging surface includes a plurality of holes with raised edges surrounding the holes.

8. The drop wire clamp of claim 1, wherein the first and second sidewalls of the shell channel and the wedge channel include smooth surfaces.

9. The drop wire clamp of claim 1, wherein the shell base further includes a first member and a second member, wherein the first and second members are coupled at the first sidewall and second sidewall of the shell channel respectively, and
wherein the wedge base further includes a first member and a second member, wherein the first and second members of the wedge base are coupled to the first sidewall and second sidewall of the wedge channel respectively, and
wherein the first members of the shell base and wedge base engage each other in the second position and the second members of the shell base and wedge base engage each other in the second position.

10. The drop wire clamp of claim 1, wherein the first wall of the outer shell and the second wall of the outer shell extend upwardly from the shell base, wherein each of the first and second walls of the shell base include a guide conduit at an end thereof away from the shell base, and
the monolithic inner wedge includes a first wall and a second wall extending from the wedge base, wherein respective ends of the first and second wall of the wedge base slide within respective guide conduits of the outer shell.

11. The drop wire clamp of claim 1, wherein the outer shell has a first end, a second end, and a longitudinal dimension between the first and second ends, wherein a height dimension of the first end is smaller than a height dimension of the second end; and
wherein the monolithic inner wedge has a first end, a second end, and a longitudinal dimension between the first and second ends, wherein a height dimension of the first end of the monolithic inner wedge is smaller than a height dimension of the second end of the monolithic inner wedge.

12. The drop wire clamp of claim 11, wherein the longitudinal dimension of the outer shell is less than the longitudinal dimension of the monolithic inner wedge.

13. The drop wire clamp of claim 1, further comprising a bail wire secured to the monolithic inner wedge.

14. The drop wire clamp of claim 13, wherein the bail wire is monolithic with the monolithic inner wedge.

15. The drop wire clamp of claim 1, wherein the containment structure comprises an oblong configuration.

16. The drop wire clamp of claim 1, wherein the drop wire clamp comprises at least one of stainless steel, aluminum, and plastic.

17. The drop wire clamp of claim 1, wherein the containment structure does not impart any direct compressive forces to an optical fiber bundle within a cable contained within the containment structure.

18. A method of securing a cable in a drop wire clamp comprising:
providing a drop wire clamp having:
an outer shell having a first wall, a second wall, and a shell base to couple the first wall with the second wall, wherein the shell base defines a shell channel; and
a monolithic inner wedge receivable in the outer shell and movable between a first position and a second position within the outer shell, the monolithic inner wedge having a wedge base defining a wedge channel, wherein the shell channel aligns with the wedge channel in the second position to form a containment structure to house a cable therein, wherein the containment structure includes a length dimension and a width dimension, wherein the length dimension is greater than the width dimension and the length dimension extends in a same direction as the shell base of the outer shell;
inserting a cable within either the shell channel or the wedge channel when the monolithic inner wedge is in the first position; and
moving the monolithic inner wedge between the first position to the second position to secure the cable within the containment structure such that a transverse dimension of the cable extends in the direction of the first wall and second wall.

19. The method of claim 18, wherein a bail wire is secured to the monolithic inner wedge, and wherein pulling the bail wire moves the monolithic inner wedge between the first position and the second position.

20. The method of claim 19, further comprising securing the bail wire to at least one of a pole, house, and building support attachment.

21. A drop wire clamp to secure a cable, consisting essentially of:
an outer shell having a first wall, a second wall, and a shell base to couple the first wall with the second wall, wherein the shell base defines a shell channel; and
an inner wedge receivable in the outer shell and movable between a first position and a second position within the outer shell, the inner wedge having a wedge base defining a wedge channel,
wherein the shell channel aligns with the wedge channel in the second position to form a containment structure to house a cable therein, wherein the containment structure includes a length dimension and a width dimension, wherein the length dimension is greater than the width dimension and the length dimension extends in a same direction as the shell base of the outer shell.

22. A two-piece drop wire clamp to secure a cable, comprising:
a first component, wherein the first component is an outer shell having a first wall, a second wall, and a shell base to couple the first wall with the second wall, wherein the shell base defines a shell channel; and
a second component, wherein the second component is an inner wedge receivable in the outer shell and movable between a first position and a second position within the outer shell, the inner wedge having a wedge base defining a wedge channel,
wherein the shell channel aligns with the wedge channel in the second position to form a containment structure to house a cable therein, wherein the containment structure includes a length dimension and a width dimension, wherein the length dimension is greater than the width dimension and the length dimension extends in a same direction as the shell base of the outer shell.
